(19) United States
(12) Patent Application Publication
(10) Pub. No.: US 2024/0422780 A1
(43) Pub. Date: Dec. 19, 2024

(54) SYSTEM AND METHOD FOR FRAME PROTECTION

(71) Applicant: NXP USA, Inc., Austin, TX (US)

(72) Inventors: Liwen Chu, San Ramon, CA (US); Kiseon Ryu, San Diego, CA (US); Huizhao Wang, San Jose, CA (US); Hongyuan Zhang, Fremont, CA (US)

(21) Appl. No.: 18/744,374

(22) Filed: Jun. 14, 2024

Related U.S. Application Data
(60) Provisional application No. 63/508,331, filed on Jun. 15, 2023.
(60) Provisional application No. 63/520,044, filed on Aug. 16, 2023.
(60) Provisional application No. 63/589,413, filed on Oct. 11, 2023.

(51) Int. Cl. H04W 72/20; H04W 84/12

(52) U.S. Cl. CPC H04W 72/20; H04W 84/12

(57) ABSTRACT

Embodiments of a method and apparatus for communications are disclosed. In an embodiment, a communications device includes a controller configured to generate a protected control frame and a transceiver configured to transmit the protected control frame to a second communications device. The protected control frame includes a protected trigger frame, a protected block acknowledgement (BA) frame, or a protected block acknowledgement request (BAR) frame.

### CROSS-REFERENCE TO RELATED APPLICATIONS

This application is entitled to the benefit of U.S. Provisional Patent Application Ser. No. 63/508,331, filed on Jun. 15, 2023, U.S. Provisional Patent Application Ser. No. 63/520,044, filed on Aug. 16, 2023, and U.S. Provisional Patent Application Ser. No. 63/589,413, filed on Oct. 11, 2023, the contents of which are incorporated by reference herein.

### BACKGROUND

Wireless communications devices, e.g., access points (APs) or non-AP devices can transmit various types of information using different transmission techniques. For example, various applications, such as, Internet of Things (IoT) applications can conduct wireless local area network (WLAN) communications, for example, based on Institute of Electrical and Electronics Engineers (IEEE) 802.11 family of standards (e.g., Wi-Fi standards). In multi-link communications, an access point (AP) multi-link device (MLD) may wirelessly transmit data to one or more wireless stations in a non-AP MLD through one or more wireless communications links. Some applications, for example, video teleconferencing, streaming entertainment, high definition (HD) video surveillance applications, outdoor video sharing applications, etc., require relatively high system throughput. To facilitate the proper data transmission within a wireless communications system, there is a need for wireless communications technology that can efficiently and securely convey communications signaling information, for example, information related to data, communications links, and/or multi-link devices (e.g., operation and/or capability parameters of multi-link devices) within a multi-link communications system.

### SUMMARY

Embodiments of a method and apparatus for communications are disclosed. In an embodiment, a communications device includes a controller configured to generate a protected control frame and a transceiver configured to transmit the protected control frame to a second communications device. The protected control frame at least includes a protected Trigger frame, a protected block acknowledgement (BA) frame or a protected block acknowledgement request (BAR) frame. Other embodiments are also disclosed.

In an embodiment, the communications device includes a wireless device that is compatible with an Institute of Electrical and Electronics Engineers (IEEE) 802.11 protocol.

In an embodiment, the communications device includes a wireless multi-link device (MLD), the second communications device includes a second wireless MLD, and the transceiver includes a wireless transceiver configured to transmit the protected control frame to the second wireless MLD through a wireless link between the wireless MLD and the second wireless MLD.

In an embodiment, the protected control frame includes the protected trigger frame, a protected compressed BAR frame, or a protected Multi-Traffic Identifier (TID) BAR frame.

In an embodiment, the protected control frame includes a protected Multi-User Request To Send (MU-RTS) frame that is used to replace a RTS to solicit a Clear to Send (CTS) by an access point (AP) or a station (STA). In an embodiment, the protected control frame includes a protected multi-station (STA) BA frame.

In an embodiment, the protected multi-STA BA frame is used to replace a compressed BA frame.

In an embodiment, the protected multi-STA BA frame is used to replace a Multi-Traffic Identifier (TID) BA frame.

In an embodiment, the protected multi-STA BA frame is used to replace an acknowledgement (Ack).

In an embodiment, the controller is further configured to generate the protected control frame using a control frame peer transient key (CPTK), the communications device includes a wireless multi-link device (MLD), the second communications device includes a second wireless MLD, and each wireless link between the wireless MLD and the second wireless MLD has its own packet number (PN) space.

In an embodiment, the controller is further configured to generate the protected control frame using a control frame group temporal key (CGTK), the communications device includes a wireless multi-link device (MLD), the second communications device includes a second wireless MLD, and each wireless link between the wireless MLD and the second wireless MLD has its own CTGK and its own packet number (PN) space.

In an embodiment, the protected control frame includes the protected BAR frame, and key identification (ID) information and frame protection indication information are carried in a reserved subfield of a BAR control field of the protected BAR frame.

In an embodiment, packet number (PN) information and message integrity check (MIC) information are located before a frame check sequence (FCS).

In an embodiment, the protected control frame includes the protected BA frame, and key identification (ID) information and frame protection indication information are carried in a reserved subfield of a BA control field of a Media Access Control (MAC) header of the protected BA frame.

In an embodiment, packet number (PN) information and message integrity check (MIC) information are located after a last Per Association ID (AID) Traffic Identifier (TID) Info field.

In an embodiment, a wireless multi-link device (MLD) includes a controller configured to generate a protected control frame using a transient key or a group key and a wireless transceiver configured to transmit the protected control frame to a second wireless MLD through a wireless link between the wireless MLD and the second wireless MLD. The protected control frame includes protected Trigger frame, a protected block acknowledgement (BA) frame or a protected block acknowledgement request (BAR) frame.

In an embodiment, the protected control frame includes a protected compressed BAR frame or a protected Multi-Traffic Identifier (TID) BAR frame.

In an embodiment, the protected control frame includes a protected multi-station (STA) BA frame.

In an embodiment, the controller is further configured to generate the protected control frame using a control frame peer transient key (CPTK), and each wireless link between the wireless MLD and the second wireless MLD has its own packet number (PN) space.

In an embodiment, a method for wireless communications includes at a first communications device, generating a protected control frame, wherein the protected control frame includes a protected trigger frame, a protected block acknowledgement (BA) frame, or a protected block acknowledgement request (BAR) frame, and from the first communications device, wirelessly transmitting the protected control frame to a second communications device.

Other aspects in accordance with the invention will become apparent from the following detailed description, taken in conjunction with the accompanying drawings, illustrated by way of example of the principles of the invention.

### BRIEF DESCRIPTION OF THE DRAWINGS

FIG. 1 depicts a wireless communications system in accordance with an embodiment of the invention.

FIG. 2 depicts a multi-link (ML) communications system that is used for wireless communications in accordance with an embodiment of the invention.

FIG. 3 depicts a wireless device in accordance with an embodiment of the invention.

FIG. 4 depicts an example BAR frame variant encoding table.

FIG. 5 depicts an example BA frame variant encoding table.

FIG. 6 illustrates a Galois/Counter Mode Protection (GCMP)/Counter Mode with Cipher Block Chaining Message Authentication Code Protocol (CCMP) header field format in accordance with an embodiment of the invention.

FIG. 7 illustrates a command and status (CAS) High Efficiency (HE) control field format in accordance with an embodiment of the invention.

FIG. 8 illustrates a MAC protocol data unit (MPDU) delimiter format in accordance with an embodiment of the invention.

FIG. 9 illustrates a BAR Control field format in accordance with an embodiment of the invention.

FIG. 10 illustrates a BA Control field format in accordance with an embodiment of the invention.

FIG. 11 is a process flow diagram of a method for wireless communications in accordance with an embodiment of the invention.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment”, “an embodiment”, or similar language means that a particular feature, structure, or characteristic described in connection with the indicated embodiment is included in at least one embodiment of the present invention. Thus, the phrases “in one embodiment”, “in an embodiment”, and similar language throughout this specification may, but do not necessarily, all refer to the same embodiment.

In embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Institute of Electrical and Electronics Engineer (IEEE) 802.11 communication protocol.

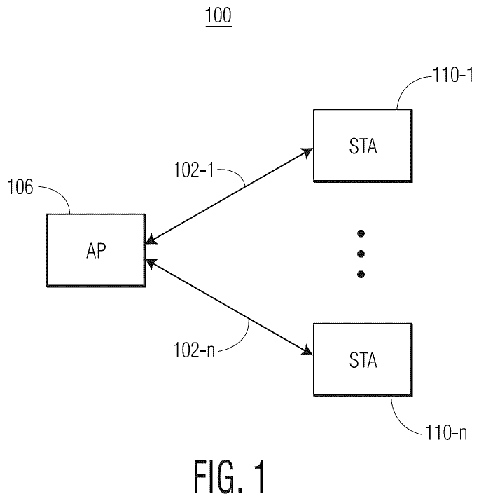

FIG. 1 depicts a wireless (e.g., WiFi) communications system 100 in accordance with an embodiment of the invention. In the embodiment depicted in FIG. 1, the wireless communications system 100 includes at least one AP 106 and at least one station (STA) 110-1, . . . , 110-n, where n is a positive integer. The wireless communications system can be used in various applications, such as industrial applications, medical applications, computer applications, and/or consumer or enterprise applications. In some embodiments, the wireless communications system is compatible with an IEEE 802.11 protocol. Although the depicted wireless communications system 100 is shown in FIG. 1 with certain components and described with certain functionality herein, other embodiments of the wireless communications system may include fewer or more components to implement the same, less, or more functionality. For example, in some embodiments, the wireless communications system includes multiple APs with multiple STAs, one AP with one STA, or one AP with multiple STAs. In another example, although the wireless communications system is shown in FIG. 1 as being connected in a certain topology, the network topology of the wireless communications system is not limited to the topology shown in FIG. 1. In some embodiments, the wireless communications system 100 described with reference to FIG. 1 involves single-link communications and the AP and the STA communicate through single communications link. In some embodiments, the wireless communications system 100 described with reference to FIG. 1 involves multi-link communications and the AP and the STA communicate through multiple communications links. Furthermore, the techniques described herein may also be applicable to each link of a multi-link communications system.

In the embodiment depicted in FIG. 1, the AP 106 may be implemented in hardware (e.g., circuits), software, firmware, or a combination thereof. The AP 106 may be fully or partially implemented as an integrated circuit (IC) device. In some embodiments, the AP 106 is a wireless AP compatible with at least one WLAN communications protocol (e.g., at least one IEEE 802.11 protocol). In some embodiments, the AP is a wireless AP that connects to a local area network (LAN) and/or to a backbone network (e.g., the Internet) through a wired connection and that wirelessly connects to one or more wireless stations (STAs), for example, through one or more WLAN communications protocols, such as the IEEE 802.11 protocol. In some embodiments, the AP includes at least one antenna, at least one transceiver operably connected to the at least one antenna, and at least one controller operably connected to the corresponding transceiver. In some embodiments, the transceiver includes a physical layer (PHY) device. The controller may be configured to control the transceiver to process received packets through the antenna. In some embodiments, the controller is implemented within a processor, such as a microcontroller, a host processor, a host, a digital signal processor (DSP), or a central processing unit (CPU), which can be integrated in a corresponding transceiver. In some embodiments, the AP 106 (e.g., a controller or a transceiver of the AP) implements upper layer Media Access Control (MAC) functionalities (e.g., beacon acknowledgement establishment, reordering of frames, etc.) and/or lower layer MAC functionalities (e.g., backoff, frame transmission, frame reception, etc.). Although the wireless communications system 100 is shown in FIG. 1 as including one AP, other embodiments of the wireless communications system 100 may include multiple APs. In these embodiments, each of the APs of the wireless communications system 100 may operate in a different frequency band. For example, one AP may operate in a 2.4 gigahertz (GHz) frequency band and another AP may operate in a 5 GHz frequency band.

In the embodiment depicted in FIG. 1, each of the at least one STA 110-1, . . . , 110-n may be implemented in hardware (e.g., circuits), software, firmware, or a combination thereof. The STA 110-1, . . . , or 110-n may be fully or partially implemented as IC devices. In some embodiments, the STA 110-1, . . . , or 110-n is a communication device compatible with at least one IEEE 802.11 protocol. In some embodiments, the STA 110-1, . . . , or 110-n is implemented in a laptop, a desktop personal computer (PC), a mobile phone, or other communications device that supports at least one WLAN communications protocol. In some embodiments, the STA 110-1, . . . , or 110-n implements a common MAC data service interface and a lower layer MAC data service interface. In some embodiments, the STA 110-1, . . . , or 110-n includes at least one antenna, at least one transceiver operably connected to the at least one antenna, and at least one controller connected to the corresponding transceiver. In some embodiments, the transceiver includes a PHY device. The controller may be configured to control the transceiver to process received packets through the antenna. In some embodiments, the controller is implemented within a processor, such as a microcontroller, a host processor, a host, a DSP, or a CPU, which can be integrated in a corresponding transceiver.

In the embodiment depicted in FIG. 1, the AP 106 communicates with the at least one STA 110-1, . . . , 110-n via a communication link 102-1, . . . , 102-n, where n is a positive integer. In some embodiments, data communicated between the AP and the at least one STA 110-1, . . . , 110-n includes MAC protocol data units (MPDUs). An MPDU may include a frame header, a frame body, and a trailer with the MPDU payload encapsulated in the frame body.

In some embodiments of a wireless communications system, a wireless device, e.g., an access point (AP) multi-link device (MLD) of a wireless local area network (WLAN) may transmit data to at least one associated station (STA) MLD. The AP MLD may be configured to operate with associated STA MLDs according to a communication protocol. For example, the communication protocol may be an Ultra High Reliability (UHR) communication protocol, or Institute of Electrical and Electronics Engineers (IEEE) 802.11bn communication protocol. In some embodiments of the wireless communications system described herein, different associated STAs within range of an AP operating according to the UHR communication protocol are configured to operate according to at least one other communication protocol, which defines operation in a Basic Service Set (BSS) with the AP, but are generally affiliated with lower reliable protocols. The lower reliable communication protocols (e.g., EHT communication protocol that is compatible with IEEE 802.11be standards, High Efficiency (HE) communication protocol that is compatible with IEEE 802.11ax standards, Very High Throughput (VHT) communication protocol that is compatible with IEEE 802.11ac standards, etc.) may be collectively referred to herein as “legacy” communication protocols.

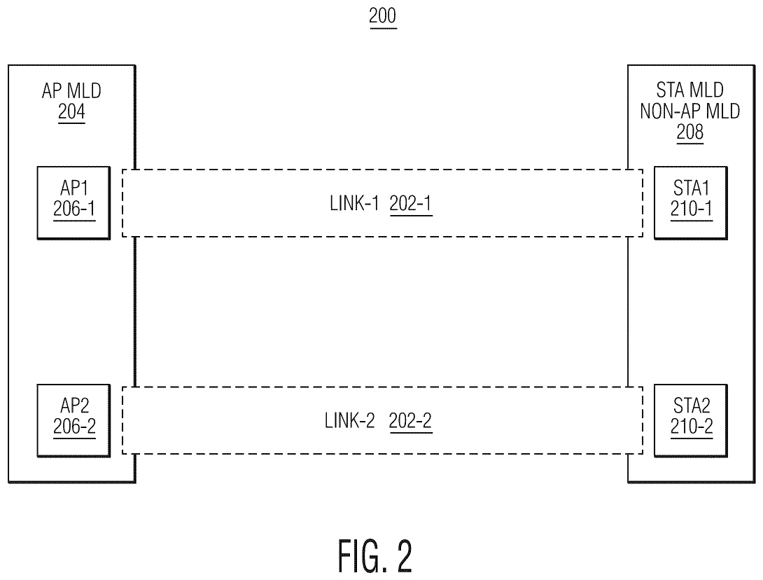

FIG. 2 depicts a multi-link (ML) communications system 200 that is used for wireless (e.g., WiFi) communications in accordance with an embodiment of the invention. In the embodiment depicted in FIG. 2, the multi-link communications system includes one AP multi-link device, which is implemented as AP MLD 204, and one non-AP STA multi-link device, which is implemented as STA MLD 208. The multi-link communications system can be used in various applications, such as industrial applications, medical applications, computer applications, and/or consumer or enterprise applications. In some embodiments, the multi-link communications system may be a wireless communications system, such as a wireless communications system compatible with an IEEE 802.11 protocol. For example, the multi-link communications system may be a wireless communications system compatible with an IEEE 802.11bn protocol. Although the depicted multi-link communications system 200 is shown in FIG. 2 with certain components and described with certain functionality herein, other embodiments of the multi-link communications system may include fewer or more components to implement the same, less, or more functionality. For example, in some embodiments, the multi-link communications system includes a single AP MLD with multiple STA MLDs, or multiple AP MLDs with more than one STA MLD. In some embodiments, the legacy STAs (non-UHR STAs) may associate with one of the APs affiliated with the AP MLD. In another example, although the multi-link communications system is shown in FIG. 2 as being connected in a certain topology, the network topology of the multi-link communications system is not limited to the topology shown in FIG. 2.

In the embodiment depicted in FIG. 2, the AP MLD 204 includes two APs in two links, implemented as APs 206-1 and 206-2. In such an embodiment, the APs may be AP1 206-1 and AP2 206-2. In some embodiments, a common part of the AP MLD 204 implements upper layer Media Access Control (MAC) functionalities (e.g., beaconing, association establishment, reordering of frames, etc.) and a link specific part of the AP MLD 204, i.e., the APs 206-1 and 206-2, implement lower layer MAC functionalities (e.g., backoff, frame transmission, frame reception, etc.). The APs 206-1 and 206-2 may be implemented in hardware (e.g., circuits), software, firmware, or a combination thereof. The APs 206-1 and 206-2 may be fully or partially implemented as an integrated circuit (IC) device. In some embodiments, the APs 206-1 and 206-2 may be wireless APs compatible with at least one WLAN communications protocol (e.g., at least one IEEE 802.11 protocol). For example, the APs 206-1 and 206-2 may be wireless APs compatible with an IEEE 802.11bn protocol. In some embodiments, an AP MLD (e.g., AP MLD 204) connects to a local network (e.g., a LAN) and/or to a backbone network (e.g., the Internet) through a wired connection and wirelessly connects to wireless STAs, for example, through one or more WLAN communications protocols, such as an IEEE 802.11 protocol. In some embodiments, an AP (e.g., AP1 206-1 and/or AP2 106-2) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. In some embodiments, the at least one controller may be implemented within a processor, such as a microcontroller, a host processor, a host, a digital signal processor (DSP), or a central processing unit (CPU), which can be integrated in a corresponding transceiver. In some embodiments, each of the APs 206-1 or 206-2 of the AP MLD 204 may operate in a different BSS operating channel. For example, AP1 206-1 may operate in a 320 MHz (one million hertz) BSS operating channel at 6 Gigahertz (GHz) band and AP2 206-2 may operate in a 160 MHZ BSS operating channel at 5 GHz band. Although the AP MLD 204 is shown in FIG. 2 as including two APs, other embodiments of the AP MLD 204 may include more than two APs or only one AP.

In the embodiment depicted in FIG. 2, the non-AP STA multi-link device, implemented as STA MLD 208, includes STAs non-AP STAs 210-1 and 210-2 on two links. In such an embodiment, the non-AP STAs may be STA1 210-1 and STA2 210-2. The STAs 210-1 and 210-2 may be implemented in hardware (e.g., circuits), software, firmware, or a combination thereof. The STAs 210-1 and 210-2 may be fully or partially implemented as an IC device. In some embodiments, the non-AP STAs 210-1 and 210-2 are part of the STA MLD 208, such that the STA MLD may be a communications device that wirelessly connects to a wireless AP MLD. For example, the STA MLD 208 may be implemented in a laptop, a desktop personal computer (PC), a mobile phone, or other communications device that supports at least one WLAN communications protocol. In some embodiments, the non-AP STA MLD 208 is a communications device compatible with at least one IEEE 802.11 protocol (e.g., an 802.11IEEE 802.11be protocol, an IEEE 802.11ax protocol, or an IEEE 802.11ac protocol). In some embodiments, the STA MLD 208 implements a common MAC data service interface and the non-AP STAs 210-1 and 210-2 implement a lower layer MAC data service interface.

In some embodiments, the AP MLD 204 and/or the STA MLD 208 may identify which communication links support multi-link operation during a multi-link operation setup phase and/or exchanges information regarding multi-link capabilities during the multi-link operation setup phase. In some embodiments, each of the non-AP STAs 210-1 and 210-2 of the STA MLD 208 may operate in a different frequency band. For example, the non-AP STA 210-1 may operate in the 2.4 GHz frequency band and the non-AP STA 210-2 may operate in the 5 GHz frequency band. In some embodiments, each STA includes at least one antenna, at least one transceiver operably connected to the at least one antenna, and at least one controller connected to the corresponding transceiver. In some embodiments, at least one transceiver includes a PHY device. The at least one controller may be configured to control the at least one transceiver to process received packets through the at least one antenna. In some embodiments, the at least one controller may be implemented within a processor, such as a microcontroller, a host processor, a host, a DSP, or a CPU, which can be integrated in a corresponding transceiver.

In the embodiment depicted in FIG. 2, the STA MLD 208 communicates with the AP MLD 204 via two communication links, e.g., link 1 202-1 and link 2 202-2. For example, each of the non-AP STAs 210-1 or 210-2 communicates with an AP 206-1 or 206-2 via corresponding communication links 202-1 or 202-2. In an embodiment, a communication link (e.g., link 1 202-1 or link 2 202-2) may include a BSS operating channel established by an AP (e.g., AP1 206-1 or AP2 206-2) that features multiple 20 MHz channels used to transmit frames (e.g., Beacon frames, management frames, etc. in Physical Layer Convergence Protocol (PLCP) Protocol Data Units (PPDUs)) between a first wireless device (e.g., an AP, an AP MLD, an STA, or an STA MLD) and a second wireless device (e.g., an AP, an AP MLD, an STA, or an STA MLD). In some embodiments, a 20 MHz channel covered by the BSS operating channel may be a punctured 20 MHz channel or an unpunctured 20 MHz channel. Although the STA MLD 208 is shown in FIG. 2 as including two non-AP STAs, other embodiments of the STA MLD 208 may include one non-AP STA or more than two non-AP STAs. In addition, although the AP MLD 204 communicates (e.g., wirelessly communicates) with the STA MLD 208 via the communications links 202-1 and 202-2, in other embodiments, the AP MLD 204 may communicate (e.g., wirelessly communicate) with the STA MLD 208 via more than two communication links or less than two communication links.

In some embodiments, a first MLD, e.g., an AP MLD or non-AP MLD (STA MLD), may transmit management frames in a multi-link operation with a second MLD, e.g., STA MLD or AP MLD, to coordinate the multi-link operation between the first MLD and the second MLD. As an example, a management frame may be a channel switch announcement frame, a (Re) Association Request frame, a (Re) Association Response frame, a Beacon frame, a Disassociation frame, an Authentication frame, and/or a Block Acknowledgement (Ack) (BA) Action frame, etc. In some embodiments, one or more management frames may be transmitted via a cross-link transmission (e.g., according to an IEEE 802.11bn communication protocol). As an example, a cross-link management frame transmission may involve a management frame being transmitted and/or received on one link (e.g., link 1 202-1) while carrying information of another link (e.g., link 2 202-2). In some embodiments, a management frame is transmitted on any link (e.g., at least one of two links or at least one of multiple links) between a first MLD (e.g., AP MLD 204) and a second MLD (e.g., STA MLD 208). As an example, a management frame may be transmitted between a first MLD and a second MLD on any link (e.g., at least one of two links or at least one of multiple links) associated with the first MLD and the second MLD.

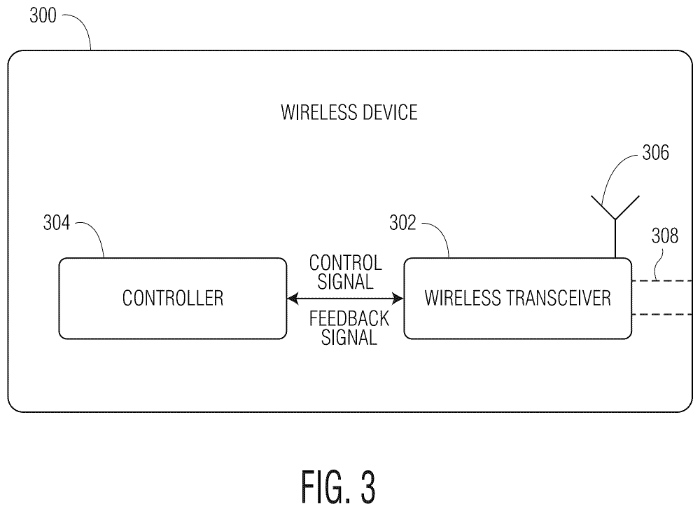

FIG. 3 depicts a wireless device 300 in accordance with an embodiment of the invention. The wireless device 300 can be used in the wireless communications system 100 depicted in FIG. 1 and/or the multi-link communications system 200 depicted in FIG. 2. For example, the wireless device 300 may be an embodiment of the AP 106 depicted in FIG. 1, the STA 110-1, . . . , 110-n depicted in FIG. 1, the APs 206-1, 206-2 depicted in FIG. 2, and/or the STAs 210-1, 210-2 depicted in FIG. 2. In the embodiment depicted in FIG. 3, the wireless device 300 includes a wireless transceiver 302, a controller 304 operably connected to the wireless transceiver, and at least one antenna 306 operably connected to the wireless transceiver. In some embodiments, the wireless device 300 may include at least one optional network port 308 operably connected to the wireless transceiver. In some embodiments, the wireless transceiver includes a physical layer (PHY) device. The wireless transceiver may be any suitable type of wireless transceiver. For example, the wireless transceiver may be a LAN transceiver (e.g., a transceiver compatible with an IEEE 802.11 protocol). In some embodiments, the wireless device 300 includes multiple transceivers. The controller may be configured to control the wireless transceiver (e.g., by generating a control signal) to process packets received through the antenna and/or the network port and/or to generate outgoing packets to be transmitted through the antenna and/or the network port. In some embodiments, the wireless transceiver transmits one or more feedback signals to the controller. In some embodiments, the controller is implemented within a processor, such as a microcontroller, a host processor, a host, a DSP, or a CPU. In some embodiments, the wireless transceiver 302 is implemented in hardware (e.g., circuits), software, firmware, or a combination thereof. The antenna may be any suitable type of antenna. For example, the antenna may be an induction type antenna such as a loop antenna or any other suitable type of induction type antenna. However, the antenna is not limited to an induction type antenna. The network port may be any suitable type of port.

In some cases, a protected Acknowledgement (Ack) or Block Ack (BA) frame can be solicited by a protected Trigger frame. In some cases, the protected Ack frame or the protected BA frame can be solicited by a Management/Data MAC protocol data unit (MPDU) or an Aggregated MAC

Protocol Data Unit (A-MPDU), respectively. In some cases, the protected RTS may be required. Some peer device of a device may be a device that does not support the control frame protection while some other peer device supports the control frame protection. Consequently, the rules regarding whether transmitting a protected responding control frame should be defined. In addition, different types of Block Acknowledgement Request (BAR) frames and BA frames are defined in some IEEE 802.11 specification (e.g., an IEEE 802.11ax specification). However, it is not clear whether all types of BAR and BA frames are protected. The protected Ack may be implemented by another control frame (Multi-STA BA) to decrease the number of protected control frame subtypes. The protected RTS may be implemented by another control frame (MU-RTS) to decrease the number of protected control frame subtypes.

In accordance with an embodiment of the invention, the controller 304 is configured to generate a protected control frame, where the protected control frame includes a protected trigger frame, a protected block acknowledgement (BA) frame or a protected block acknowledgement request (BAR) frame, and the wireless transceiver 302 is configured to transmit the protected control frame to the second communications device(s). In some embodiments, the wireless device 300 is compatible with an Institute of Electrical and Electronics Engineers (IEEE) 802.11 protocol. In some embodiments, the wireless device 300 includes a wireless non-AP STA affiliated with a STA MLD or being not affiliated with a STA MLD, the wireless transceiver 302 is further configured to transmit a protected control frame that includes a protected trigger frame, a protected compressed BAR, a protected Multi-TID BAR, and/or a protected multi-STA BA frame. In some embodiments, the wireless device 300 includes a wireless non-AP STA affiliated with a STA MLD or being not affiliated with a STA MLD, the wireless transceiver 302 is further configured to receive a protected control frame that includes a protected trigger frame, a protected compressed BAR, a protected Multi-TID BAR, and/or a protected multi-STA BA frame. In some embodiments, the wireless device 300 includes a wireless AP affiliated with an AP MLD or being not affiliated with an AP MLD, the wireless transceiver 302 is further configured to receive a protected control frame that includes a protected MU-RTS frame, a protected compressed BAR, a protected Multi-TID BAR, and/or a protected multi-STA BA frame. In some embodiments, the wireless device 300 includes a wireless AP affiliated with an AP MLD or being not affiliated with an AP MLD, the wireless transceiver 302 is further configured to transmit a protected control frame that includes a protected Trigger frame, and a protected compressed BAR, a protected Multi-TID BAR, a protected multi-STA BA frame. In some embodiments, the controller is further configured to generate the protected unicast (individually addressed) control frame using a control frame peer transient key (CPTK) for integrity protection, the wireless device 300 includes a STA/AP affiliated with a wireless MLD, the second communications device includes an AP/STA affiliated with a second wireless MLD, and each wireless link between the wireless MLD and the second wireless MLD has its own packet number (PN) space. In some embodiments, the controller is further configured to perform the integrity checking of the received protected unicast control frame using a control frame peer transient key (CPTK), the wireless device 300 includes a STA/AP affiliated with a wireless MLD, the second communications device includes an AP/STA affiliated with a second wireless MLD, and each wireless link between the wireless MLD and the second wireless MLD has its own packet number (PN) space. In some embodiment, the CPTK is negotiated between the first MLD and the second MLD for all the links between the two MLDs. In some embodiments, the control frame protection includes the encryption/decryption of the control frame. In some embodiments, the controller is further configured to generate the protected group-addressed control frame using a control frame group temporal key (CGTK) for each link of a first wireless AP MLD, the wireless device 300 includes the first wireless AP MLD, the second communication devices include multiple second wireless STA MLDs, and each wireless link between the wireless MLD and the second wireless MLDs has its own PN space. In some embodiment, one separate CGTK is announced by the first AP MLD to the second STA MLD for each link of the first AP MLD. In some embodiments, the controller is further configured to generate and transmit the protected group addressed control frame using a control frame group transient key (CGTK) in a link, the wireless device 300 includes an AP affiliated with a wireless MLD in the link, the second communication devices include the STAs affiliated with a second wireless MLDs in the link, and each wireless link between the wireless MLD and the second wireless MLDs has its own packet number (PN) space. In some embodiments, the controller is further configured to perform integrity check of the received protected group addressed control frame using a control frame group transient key (CGTK) in a link, the wireless device 300 includes a AP affiliated with a wireless MLD in the link, the second communication devices include multiple STA MPDs where one STA is affiliated with a second wireless MLD in the link, and each wireless link between the wireless MLD and the second wireless MLDs has its own packet number (PN) space. In some embodiments, the protected control frame includes the protected BAR frame, and key identification (ID) information and frame protection indication information are carried in the current reserved bits of a BAR control field of the protected BAR frame. In some embodiment, the AP MLD and its peer non-AP MLD have at most two CPTKs where one bit is used to carry key identification (ID) information. In some embodiment, one bit is used to carry frame protection indication information. In some embodiments, PN information and message integrity check (MIC) information are located before a frame check sequence (FCS) and a padding field if padding is required to be carried in the protected BAR. In some embodiments, the protected control frame includes the protected BA frame, and key ID information and frame protection indication information are carried in the current reserved bits of a BA control field of the protected BA frame. In some embodiment, the AP MLD and its peer non-AP MLD have at most two CPTKs where one bit is used to carry key identification (ID) information. In some embodiment, one bit is used to carry frame protection indication information. In some embodiments, PN information and MIC information are located after a last Per Association ID (AID) Traffic Identifier (TID) Info field and before a padding field if padding is required to be carried in the protected BAR frame. In some embodiments, the wireless device is a component of a multi-link device (MLD).

In some embodiments, protected Block Ack Request (BAR) Type and BA Type are implemented such that a protected format of a compressed BAR frame or a Multi-Traffic Identifier (TID) BAR frame is defined for a soliciting a protected BA frame if both the transmitter and the recipient of the frame support the control frame protection, for example, by the wireless communications system 100 depicted in FIG. 1, the multi-link (ML) communications system 200 depicted in FIG. 2, and/or the wireless device 300 depicted in FIG. 3. In some embodiments, a single-TID A-MPDU and/or a multi-TID A-MPDU may explicitly indicate the soliciting of an immediate responding acknowledgement being protected through integrity protection if both the transmitter and the recipient of the frame support the control frame protection. For Group Cast With Retries (GCR) BAR, in a first option, a protected format of a Group Cast With Retries (GCR) BAR frame is defined, for example, by the wireless device 300 depicted in FIG. 3 if the protection of a GCR multi-user (MU)-BAR frame is defined. For GCR BAR, in a second option, a protected format of GCR BAR is not defined, for example, by the wireless device 300 depicted in FIG. 3 if the protection of a GCR MU-BAR is defined. For general link (GLK)-GCR BAR, in a first option, a protected format of a general link (GLK)-GCR BAR frame is defined, for example, by the wireless device 300 depicted in FIG. 3. For GLK-GCR BAR, in a second option, a protected format of a GLK-GCR BAR frame is not defined, for example, by the wireless device 300 depicted in FIG. 3.

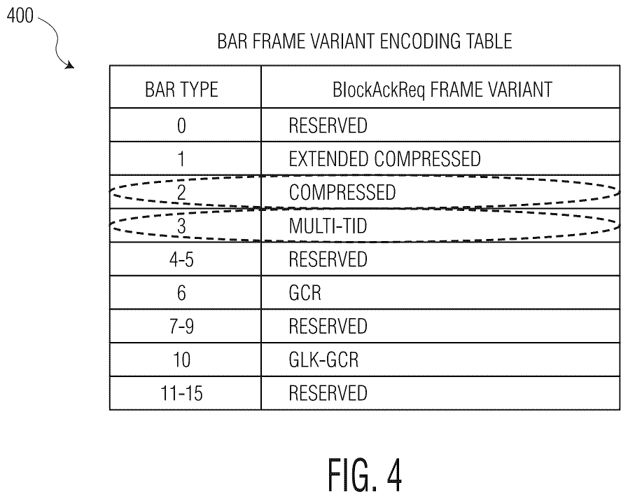

FIG. 4 depicts an example BAR frame variant encoding table 400. In the example BAR frame variant encoding table 400 depicted in FIG. 4, BAR type values and corresponding BAR frame variant information are listed. For example, a BAR type value of 2 corresponds to a compressed BAR frame variant, while a BAR type value of 3 corresponds to a multi-TID BAR frame variant. In some embodiments, a protected format of a compressed BAR frame or a Multi-TID BAR frame is defined, for example, by the wireless device 300 depicted in FIG. 3 for a soliciting BA frame.

In some embodiments, protected Block Ack Request (BAR) Type and BA Type are implemented such that a protected format of a Multi-Station (STA) BA frame is defined, for example, by the wireless communications system 100 depicted in FIG. 1, the multi-link (ML) communications system 200 depicted in FIG. 2, and/or the wireless device 300 depicted in FIG. 3. In some embodiments, a protected format of a Compressed BA frame, a Multi-TID BA frame, an Enhanced directional multi-Gigabit (EDMG) Multi-STA BA frame, and/or an EDMG Compressed BA frame is not defined, for example, by the wireless device 300 depicted in FIG. 3. In some embodiments, if/when a compressed BA frame that requires protection is solicited, i.e., both the transmitter and the receiver of the solicited compressed BA frame support the control frame protection, a protected Multi-STA BA frame is used. In some embodiments, if/when a multi-TID BA frame that requires protection is solicited, i.e., both the transmitter and the receiver of the solicited multi-TID BA frame support the control frame protection, a protected Multi-STA BA frame is used. For GCR BA, in a first option, a protected format of a GCR BA frame is defined, for example, by the wireless device 300 depicted in FIG. 3 if the protection of a GCR MU-BAR frame is defined. For GCR BA, in a second option, a protected format of a GCR BA frame is not defined, for example, by the wireless device 300 depicted in FIG. 3 if the protection of a GCR MU-BAR frame is defined. For GLK-GCR BA, in a first option, a protected format of a GLK-GCR BA frame is defined, for example, by the wireless device 300 depicted in FIG. 3. For GLK-GCR BA, in a second option, a protected format of a GLK-GCR BA frame is not defined, for example, by the wireless device 300 depicted in FIG. 3.

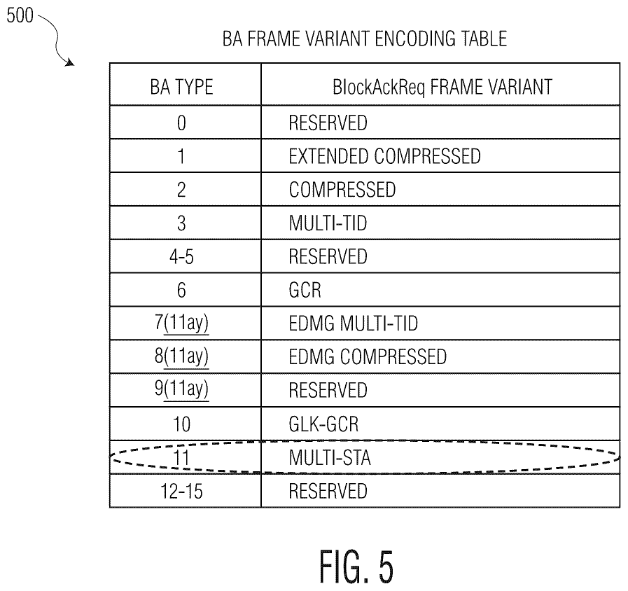

FIG. 5 depicts an example BA frame variant encoding table 500. In the example BA frame variant encoding table 500 depicted in FIG. 5, BA type values and corresponding BA frame variant information are listed. For example, a BA type value of 11 corresponds to a multi-STA BA frame variant. In some embodiments, a protected format of a multi-STA BA frame is defined, for example, by the wireless device 300 depicted in FIG. 3.

Some implementations of replacing an acknowledgement (Ack) frame with a Multi-STA BA frame, for example, by the wireless communications system 100 depicted in FIG. 1, the multi-link (ML) communications system 200 depicted in FIG. 2, and/or the wireless device 300 depicted in FIG. 3 are described. In some embodiments, a STA (e.g., the wireless device 300 depicted in FIG. 3) transmits a protected Multi-STA BA frame, instead of an acknowledgement (Ack) frame, if a Quality of service (QOS) Data frame or a Management frame solicits the acknowledgement that is not a BA frame and the responding Control frame needs to be protected, i.e., when both the transmitter and the receiver of the acknowledgement support the control frame protection.

Some implementations of disallowing Request To Send (RTS), for example, by the wireless communications system 100 depicted in FIG. 1, the multi-link (ML) communications system 200 depicted in FIG. 2, and/or the wireless device 300 depicted in FIG. 3 are described, assuming that RTS is not a protected Control frame. In some embodiments, for AP side, RTS cannot be used by an AP (e.g., the wireless device 300 depicted in FIG. 3) that enables the Control frame protection to a STA enabling the control frame protection. Instead, the protected multi-user (MU)-RTS is used by the AP. In some embodiments, RTS cannot be used by a STA (e.g., the wireless device 300 depicted in FIG. 3) that enables the Control frame protection to its associated AP enabling the control frame protection. Instead, the protected multi-user (MU)-RTS is used by the STA. In some embodiments, the AP/STA that enables the Control frame protection cannot perform the dynamic bandwidth (BW) negotiation to a peer device enabling the control frame protection. In some embodiments, for STA side, if a STA enables control frame protection, the STA needs to support the transmission of the MU-RTS. In some embodiments, the STA that enables the Control frame protection cannot perform the dynamic BW negotiation to the AP enabling the control frame protection. In some embodiments, the dynamic BW negation indication is added to the protected MU-RTS frame. The AP and the STA can be similar to or the same as the wireless device 300 depicted in FIG. 3.

Some implementations of soliciting protected responding frame, for example, by the wireless communications system 100 depicted in FIG. 1, the multi-link (ML) communications system 200 depicted in FIG. 2, and/or the wireless device 300 depicted in FIG. 3 are described. In some embodiments, if/when an AP (e.g., the wireless device 300 depicted in FIG. 3) that enables its control frame protection intends to solicit a protected BA frame in a Trigger-based (TB) PPDU from at least one STA that enables its control frame protection through a MU-BAR frame, the AP needs to transmit a protected MU-BAR frame. In some embodiments, if a STA or an AP that enables its control frame protection intends to solicit the acknowledgement for its a-MPDU through a BAR frame from its peer device that enables its control frame protection, the STA/AP needs to transmit a protected BAR frame. In some embodiments, an AP that enables its control frame protection needs to transmit a protected Basic Trigger frame being aggregated with an A-MPDU or another MPDU that solicits Ack to a STA that enables its control frame protection in order for the STA to respond with a protected Multi-STA BA frame. The APs and the STAs can be similar to or the same as the wireless device 300 depicted in FIG. 3. In some embodiment, if an AP supporting the control frame protection needs to transmit a Trigger frame addressed to one or multiple STAs where at least one recipient supports control frame protection, the Trigger frame is protected.

In some embodiments, when transmitting Data/Management frame(s) to solicit Ack/BA frames, a STA or an AP (e.g., the wireless device 300 depicted in FIG. 3) that enables the control frame protection needs to transmit the frame (e.g., a QoS Data frame or a Management frame) that solicits Ack (or frames that solicit BA) with the explicit indication that the responding control frame is the protected frame. In some embodiments, whether the responding frame should be protected is indicated in MPDU Delimiter by using the current reserved bit. In some embodiments, whether the responding frame should be protected is indicated in the GCMP/CCMP Header by using the current reserved bit. In some embodiments, whether the responding frame should be protected is indicated in a newly defined HE Control field or by updating the current HE Control field, e.g., by using one reserved bit in a command and status (CAS) control field. In some embodiments, if the peer device that solicits the Ack/BA enables control frame protection and the transmitter of the solicited Ack/BA enable control frame protection, the responding frame is protected.

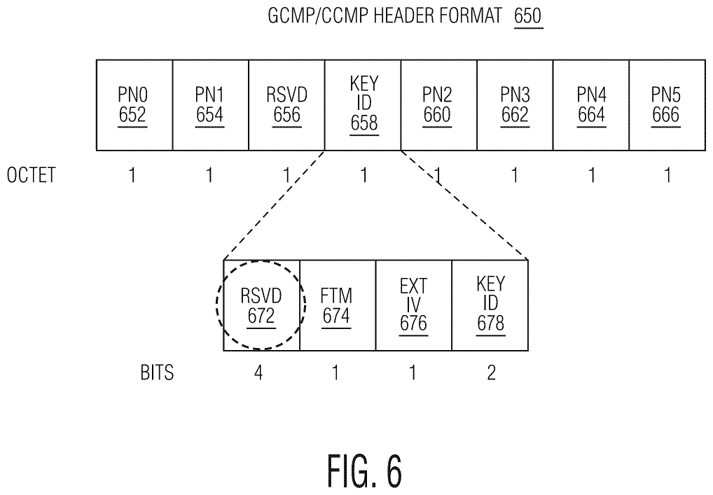

FIG. 6 illustrates a GCMP/CCMP header format 650 in accordance with an embodiment of the invention. The GCMP/CCMP header format 650 (e.g., in a unicast Data/Management frame) illustrated in FIG. 6 is one option to indicate whether the solicited control frame by the Data/Management frame is protected or not for communications by the wireless communications system 100 depicted in FIG. 1, the multi-link (ML) communications system 200 depicted in FIG. 2, and/or the wireless device 300 depicted in FIG. 3. In the embodiment depicted in FIG. 6, the GCMP/CCMP header format 650 includes one-octet packet number fields PN0, PN1, PN2, PN3, PN4, PN5 652, 654, 660, 662, 664, 666, a one-octet reserved (Rsvd) field 656, a one-octet key ID filed 658 that may contain key identification information, which may include one-bit fine time measurement (FTM) subfield 674, one-bit Ext IV subfield 676, two-bit Key ID subfield 678, and 4-bit reserved (Rsvd) subfield 672. Among the current reserved bits, one bit (e.g. one bit of Rsvd in Key ID octet) can be used as the responding protected frame indication information field whose value 1 indicates that the protected responding control frame is solicited.

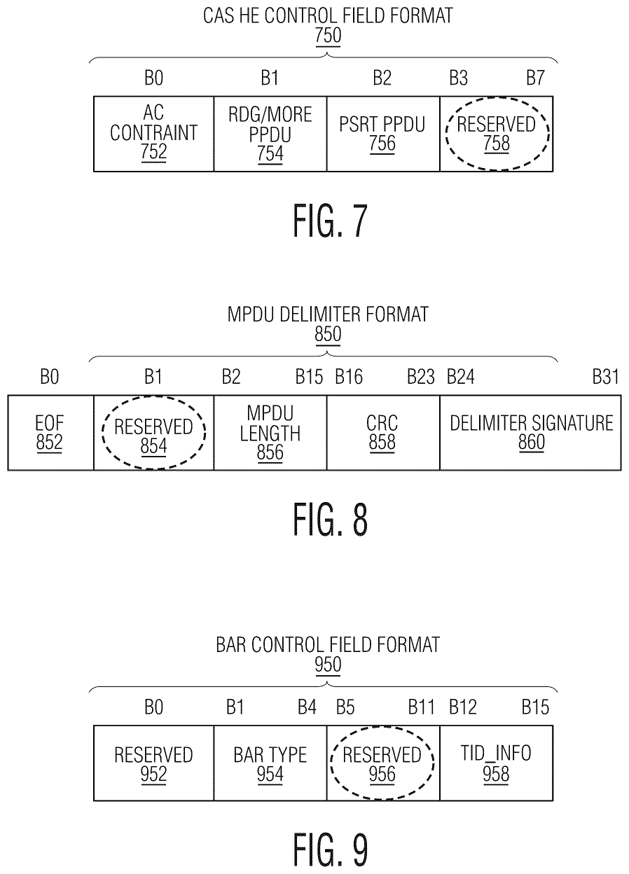

FIG. 7 illustrates an updated CAS HE control field format 750 in accordance with an embodiment of the invention. The CAS HE control field format 750 in a unicast Data/Management frame illustrated in FIG. 7 is one option to indicate whether the solicited control frame by the Data/Management frame is protected or not for communications by the wireless communications system 100 depicted in FIG. 1, the multi-link (ML) communications system 200 depicted in FIG. 2, and/or the wireless device 300 depicted in FIG. 3. In the embodiment depicted in FIG. 7, the CAS HE control field format 750 includes an AC constraint subfield 752 (e.g., one-bit) that may contain AC constraint information of the Data frames transmitted by the TXOP responder in reverse direction (RD) operation, a Reverse direction grant (RDG)/More PPDU subfield 754 (e.g., one-bit) that may contain RDG/More PPDU information, a parameterized spatial reuse transmission (PSRT) PPDU subfield 756 (e.g., one-bit) that may contain PSRT PPDU information, and a reserved subfield 758 (e.g., five-bit) that may contain a current reserved bit used to carry responding protected frame indication information, i.e., when the responding protected frame indication information field is set to 1 in a Data/Management frame, the solicited responding control frame by the Data/Management frame is protected.

FIG. 8 illustrates an updated MPDU delimiter format 850 in accordance with an embodiment of the invention. The MPDU delimiter format 850 preceding a Data/Management frame illustrated in FIG. 8 is one option to indicate whether the solicited control frame by the Data/Management frame is protected or not for communications by the wireless communications system 100 depicted in FIG. 1, the multi-link (ML) communications system 200 depicted in FIG. 2, and/or the wireless device 300 depicted in FIG. 3. In the embodiment depicted in FIG. 8, the MPDU delimiter format 850 preceding a Data/Management frame includes an end-of-frame (EOF) subfield 852 (e.g., one-bit) that may contain EOF information, a current reserved subfield 854 (e.g., one-bit) that can be used as responding protected frame indication information field whose value equal to 1 indicating that the protected responding control frame is solicited by the Data/Management frame, an MPDU length subfield 856 (e.g., fourteen-bit) that may contain MPDU length information, a cyclic redundancy check (CRC) subfield 858 (e.g., eight-bit) that may contain CRC information, and a delimiter signature subfield 860 (e.g., eight-bit) that may contain delimiter signature information.

Some implementations of protected soliciting control frames, for example, by the wireless communications system 100 depicted in FIG. 1, the multi-link (ML) communications system 200 depicted in FIG. 2, and/or the wireless device 300 depicted in FIG. 3 are described. In some embodiments, a STA or an AP (e.g., the wireless device 300 depicted in FIG. 3) that enables its control frame protection cannot transmit a RTS to its peer device that enables its control frame protection. Instead, the protected MU-RTS is transmitted. In some embodiments, when an AP enables its control frame protection and intends to solicit a TB PPDU from at least one STA that enables its control frame protection, the protected Trigger is transmitted. In some embodiments, when an AP/STA enables its control frame protection and intends to solicit Clear to Send (CTS) from at least one STA that enables its control frame protection, the protected MU-RTS is transmitted. In some embodiments, when an AP enables its control frame protection and intends to allocate its TXOP to a STA that enables its control frame protection, the protected MU-RTS TXOP Sharing (TXS) is transmitted.

Some implementations of protected responding frame transmission, for example, by the wireless communications system 100 depicted in FIG. 1, the multi-link (ML) communications system 200 depicted in FIG. 2, and/or the wireless device 300 depicted in FIG. 3 are described. In some embodiments, if/when a STA (e.g., the wireless device 300 depicted in FIG. 3) that enables its control frame protection receives a protected MU-BAR frame that addresses the STA, the STA needs to respond with a protected Multi-STA BA frame. In these embodiments, it may be assumed that when receiving the protected MU-BAR frame to solicit a BA frame, the protected Multi-STA BA frame is transmitted.

In some embodiments, if/when a STA (e.g., the wireless device 300 depicted in FIG. 3) that enable its control frame protection receives a protected Basic Trigger frame being aggregated with a A-MPDU or another MPDU that solicit Ack, the STA needs to respond with a protected Multi-STA BA frame. In these embodiments, it may be assumed that when an Ack is solicited, the protected Multi-STA BA is transmitted.

In some embodiments, if/when a STA or an AP (e.g., the wireless device 300 depicted in FIG. 3) that enable its control frame protection receives a protected Block Ack Request frame, the STA or the AP needs to respond with a protected Multi-STA BA frame. In some embodiments, a STA enabling control frame protection notifies its switch from doze state to awake state through QoS Null with protected MAC header instead of PS-Poll. In some embodiments, if/when an AP that enable its control frame protection receives a QoS Null with the protected MAC header, the STA needs to respond with a protected Multi-STA BA frame.

In some embodiments, if/when a STA or an AP (e.g., the wireless device 300 depicted in FIG. 3) that enables the control frame protection receives a MPDU (e.g., a QoS Data frame or a Management frame) that solicits Ack (or MPDUs that solicit BA), the STA or the AP decides whether it will respond with a protected Multi-STA BA frame per the following rule:

In a first option, whether the responding control frame should be protected is indicated in an MPDU Delimiter (e.g., the MPDU Delimiter format 850 illustrated in FIG. 8) by using the reserved bit, for example, by the wireless device 300 depicted in FIG. 3.

In a second option, if/when the MAC header of a frame (e.g., a QoS Data frame or a Management frame) soliciting Ack/BA is protected, the solicited BA/Ack needs to be protected, e.g., using a Multi-STA BA frame, for example, by the wireless device 300 depicted in FIG. 3.

In a third option, whether the responding control frame should be protected is indicated in GCMP header, e.g., by using one reserved bit in the GCMP header as illustrated in FIG. 7, for example, by the wireless device 300 depicted in FIG. 3.

In a fourth option, whether the responding frame should be protected is indicated in a new defined HE Control field or by updating the current HE Control field, e.g., by using one reserved bit in the CAS Control field (e.g., the control information subfield format 750 illustrated in FIG. 7), for example, by the wireless device 300 depicted in FIG. 3.

In a fifth option, the RU indication field in an Ultra High Reliability (UHR) PHY header indicates whether the responding frame should be protected, for example, by the wireless device 300 depicted in FIG. 3.

In a sixth option, if/when the peer device that solicits the Ack/BA enables control frame protection and the transmitter of the solicited Ack/BA enables control frame protection, the responding frame is protected.

Some implementations of control frame peer transient key (CPTK)/control frame group temporal key (CGTK) and packet number (PN) Space, for example, by the wireless communications system 100 depicted in FIG. 1, the multi-link (ML) communications system 200 depicted in FIG. 2, and/or the wireless device 300 depicted in FIG. 3 are described. In some embodiments, CPTK is used for the protection of individually-addressed Control frames by integrity checking, for example, by the wireless device 300 depicted in FIG. 3. It may be difficult to have one PN space for multiple links because multiple links pick the PN numbers from one source. In some embodiments, each link has its own PN space while a CPTK is the single control frame pairwise transient key for all links between the AP MLD and its associated STA MLD. In some embodiments, each link has its own PN space and CPTK. In some embodiments, CGTK is used for group-addressed Control frames, for example, by the wireless device 300 depicted in FIG. 3. It may be difficult to have one PN space for multiple links because multiple sources pick the PN numbers from one source. In some embodiments, each link has its own PN space and one CGTK that is independent from the CTGK of another link.

Some implementations of Protected BAR, for example, by the wireless communications system 100 depicted in FIG. 1, the multi-link (ML) communications system 200 depicted in FIG. 2, and/or the wireless device 300 depicted in FIG. 3 are described. In some embodiments, the Key identification (ID) information is carried in the current reserved bits of the BAR Control field, e.g., one bit is used, for example, by the wireless device 300 depicted in FIG. 3. In this case, the protected control frame indication (e.g., protection indication of the control frame) is carried in the current reserved bits of the BAR Control field, e.g., one bit is used. In another variant, the Key ID is carried in the current reserved bits of the Frame Control field, for example, by the wireless device 300 depicted in FIG. 3. In this case, the protected control frame indication is carried in the Protected Frame subfield of the Frame Control field. In some embodiments, packet number (PN) information and message integrity check (MIC) information are located or placed right before the frame check sequence (FCS) or before the padding if padding exists in the frame.

FIG. 9 illustrates a BAR Control field format 950 in accordance with an embodiment of the invention. The BAR Control field format 950 illustrated in FIG. 9 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 9, the BAR Control field format 950 includes a reserved subfield 952 (e.g., one-bit), a BAR type subfield 954 (e.g., four-bit) that may contain BAR type information, a reserved subfield 956 (e.g., seven-bit) where one bit of reserved subfield 956 carries the protected frame indication and another bit of reserved subfield 956 carries the Key ID indication, and a TID INFO subfield 958 (e.g., four-bit) that may contain TID information. The PN+ MIC is right after BAR Info field and before FCS (or before padding field if exists).

Some implementations of Protected BA, for example, by the wireless communications system 100 depicted in FIG. 1, the multi-link (ML) communications system 200 depicted in FIG. 2, and/or the wireless device 300 depicted in FIG. 3 are described. In some embodiments, the Key ID is carried in the current reserved bits of the BA Control field, e.g., one bit is used, for example, by the wireless device 300 depicted in FIG. 3. In this case, the protected control frame indication is carried in the current reserved bits of the BA Control field, e.g., one bit is used. In another variant, the Key ID is carried in the current reserved bits of the Frame Control field, for example, by the wireless device 300 depicted in FIG. 3. In this case, the protected control frame indication is carried the Protected Frame subfield of the Frame Control field. In some embodiments, packet number (PN) information and message integrity check (MIC) information are located or placed right after the last Per AID TID Info field to acknowledge the A-MPDU or MPDU and before FCS (or before padding field if exists) in the Per AID TID Info field.

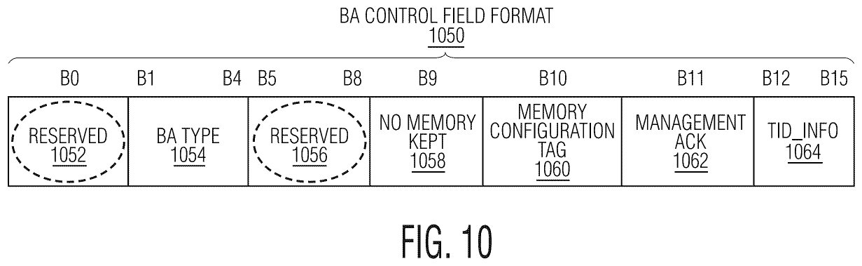

FIG. 10 illustrates a BA Control field format 1050 in accordance with an embodiment of the invention. The BA Control field format 1050 illustrated in FIG. 10 can be used for communications by the wireless communications system 100 depicted in FIG. 1, the multi-link (ML) communications system 200 depicted in FIG. 2, and/or the wireless device 300 depicted in FIG. 3. In the embodiment depicted in FIG. 10, the BA Control field format 1050 includes a reserved subfield 1052 (e.g., one-bit), a BA type subfield 1054 (e.g., four-bit) that may contain BA type information, a reserved subfield 1056 (e.g., four-bit) where one bit of reserved subfield 1056 carries the protected frame indication and another bit of reserved subfield 1056 carries the Key ID indication, a no memory Kept subfield 1058 (e.g., one-bit) that may contain no memory kept information, a memory configuration tag subfield 1060 (e.g., one-bit) that may contain memory configuration tag information, a management Ack subfield 1062 (e.g., one-bit) that may contain management Ack information, and a TID INFO subfield 1064 (e.g., four-bit) that may contain TID information.

Some implementations of Protected trigger fames, for example, by the wireless communications system 100 depicted in FIG. 1, the multi-link (ML) communications system 200 depicted in FIG. 2, and/or the wireless device 300 depicted in FIG. 3 are described. In some embodiments, the Key ID is carried in one bit of the current reserved bits of the Special User Info field or the Common Info field, for example, by the wireless device 300 depicted in FIG. 3. In some embodiments, the protected control frame indication is carried in another bit of the current reserved bits of the Special User Info field or the Common Info field. In another variant, the Key ID is carried in the current reserved bits of the Frame Control field, for example, by the wireless device 300 depicted in FIG. 3. In this case, the protected control frame indication is carried the Protected Frame subfield of the Frame Control field. In some embodiments, packet number (PN) information and message integrity check (MIC) information are carried in a Padding field after two-octet ‘1’s.

In some embodiments, for a method of improving the security for the frame exchanges between a first device and a second device, the protection indication of the control frame, Key ID, are separated from the PN, MIC with the other (sub) fields in between in a protected control frame. In some embodiments, the protection indication of the control frame and Key ID are carried in a frame control field of the MAC header. In some embodiments, PN information and MIC information are carried in padding filed of a trigger frame after two-octet ‘1’ s (0xFFFF). In some embodiments, in a Multi-STA BA, PN and MIC information are located right after the last Per AID TID Info field to acknowledge the A-MPDU or MPDU and before FCS (or the padding field if exists) in Per AID TID Info field. In some embodiments, the A-MPDU or single MPDU that solicits Ack explicitly indicates whether the responding control frame is protected or not. In some embodiments, such indication is carried in a current reserved bit of the frame control field in a management frame. In some embodiments, such indication is carried in the GCMP/CCMP header or the TID subfield of the QoS control field in a QoS data frame.

Some implementations of integrity checking of protected control frames, for example, by the wireless communications system 100 depicted in FIG. 1, the multi-link (ML) communications system 200 depicted in FIG. 2, and/or the wireless device 300 depicted in FIG. 3 are described. In some embodiments, additional authentication data (AAD) for the encryption/decryption of protected control frame includes Frame Control (FC) information, A1 (address field 1 in the frame), A2 (address field 2 in the frame) In some embodiments, additional authentication data (AAD) for the encryption/decryption of protected control frame includes FC, Duration information, A1, A2.

Some examples of usage of CPTK versus CGTK, for example, by the wireless communications system 100 depicted in FIG. 1, the multi-link (ML) communications system 200 depicted in FIG. 2, and/or the wireless device 300 depicted in FIG. 3 are described. CGTK only used for Control frame protection of protected broadcast Control frames and CPTK only used for protected unicast Control frames can simplify the implementation. However, more attacks may happen, e.g., a third party device that acquires the CGTK can transmit the protected broadcast frames on behalf of the AP and the other STAs. With CPTKs and multiple unicast protected control frame in DL MU PPDU, it can be difficult for a third party device to transmit a protected Control frame on behalf of the AP by transmitting a protected broadcast Control frame. In some embodiments, a downlink (DL) Multi-User (MU) PPDU can carry multiple protected unicast Trigger frames where each unicast Trigger frame in its own resource unit (RU) is protected by the CPTK of the recipient of the unicast Trigger frame. In some embodiments, a DL MU PPDU can carry multiple protected unicast Multi-STA BA frames where each unicast Multi-STA BA in its own RU is protected by the CPTK of the recipient of the Multi-STA BA. In some embodiments, the only exception is the MU-RTS or Buffer Status Report Poll (BSRP) Trigger used for soliciting the radio switch of the Enhanced Multilink Single-Radio (EMLSR) non-AP MLDs where the protected broadcast MU-RTS or BSRP Trigger needs to be used. In these embodiments, the CGTK is used. The APs and the STAs can be similar to or the same as the wireless device 300 depicted in FIG. 3.

In some embodiment, with multiple basic service set identifier (BSSID), all the APs in the multiple basic service set identifier (BSSID) set has the same CGTK. In some embodiments, when multiple basic service set identifier (BSSID) set is defined and an AP does not want the STAs to use “Rx Control Frame To MultiBss”, each AP of the multiple BSSID set announces its own CGTK to its associated STAs that support Control frame protection. In some embodiments, when multiple BSSID set is defined and the AP wants the STAs to use “Rx Control Frame To MultiBss”, all the APs of the multiple BSSID set announce the same CGTK to its associated STAs that support Control frame protection. The APs and the STAs can be similar to or the same as the wireless device 300 depicted in FIG. 3.

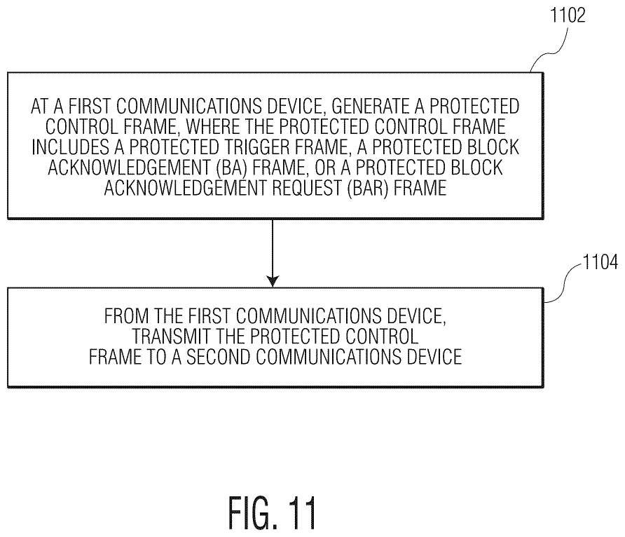

FIG. 11 is a process flow diagram of a method for wireless communications in accordance with an embodiment of the invention. At block 1102, at a first communications device, a protected control frame is generated, where the protected control frame includes a protected trigger frame, a protected block acknowledgement (BA) frame, or a protected block acknowledgement request (BAR) frame. At block 1104, from the first communications device, the protected control frame is wirelessly transmitted to a second communications device. In some embodiments, the first communications device includes a first wireless multi-link device (MLD), the second communications device includes a second wireless MLD, and the protected control frame is transmitted to the second wireless MLD through a wireless link between the first wireless MLD and the second wireless MLD. In some embodiments, the protected control frame includes the protected trigger frame, a protected compressed BAR frame, or a protected Multi-Traffic Identifier (TID) BAR frame. In some embodiments, the protected control frame includes a protected Multi-User Request To Send (MU-RTS) frame that is used to replace a RTS to solicit a Clear to Send (CTS) by an access point (AP) or a station (STA). In some embodiments, the protected control frame includes a protected multi-station (STA) BA frame. In some embodiments, the protected multi-STA BA frame is used to replace a compressed BA frame. In some embodiments, the protected multi-STA BA frame is used to replace a Multi-Traffic Identifier (TID) BA frame. In some embodiments, the protected multi-STA BA frame is used to replace an acknowledgement (Ack). In some embodiments, the protected control frame is generated using a control frame peer transient key (CPTK), the first communications device includes a first wireless multi-link device (MLD), the second communications device includes a second wireless MLD, and each wireless link between the wireless MLD and the second wireless MLD has its own packet number (PN) space. In some embodiments, the protected control frame is generated using a control frame group temporal key (CGTK), the first communications device includes a first wireless MLD, the second communications device includes a second wireless MLD, and each wireless link between the wireless MLD and the second wireless MLD has its own CTGK and its own PN space. In some embodiments, the protected control frame includes the protected BAR frame, and key identification (ID) information and frame protection indication information are carried in a reserved subfield of a BAR control field of the protected BAR frame. In some embodiments, PN information and message integrity check (MIC) information are located before a frame check sequence (FCS). In some embodiments, the protected control frame includes the protected BA frame, and key ID information and frame protection indication information are carried in a reserved subfield of a BA control field of a MAC header of the protected BA frame. In some embodiments, PN information and MIC information are located after a last Per Association ID (AID) Traffic Identifier (TID) Info field. In some embodiments, the first communications device and the second communications device are compatible with an Institute of Electrical and Electronics Engineers (IEEE) 802.11 protocol. In some embodiments, the first communications device includes a wireless access point (AP) or a non-AP wireless station (STA) device. In some embodiments, the wireless device is a component of a multi-link device (MLD). The first communications device and/or the second communications device may be the same as or similar to an embodiment of the AP 106 depicted in FIG. 1, the STA 110-1, . . . , 110-n depicted in FIG. 1, the APs 206-1, 206-2 depicted in FIG. 2, the STAs 210-1, 210-2 depicted in FIG. 2, and/or the wireless device 300 depicted in FIG. 3.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

It should also be noted that at least some of the operations for the methods described herein may be implemented using software instructions stored on a computer useable storage medium for execution by a computer. As an example, an embodiment of a computer program product includes a computer useable storage medium to store a computer readable program.

The computer-useable or computer-readable storage medium can be an electronic, magnetic, optical, electromagnetic, infrared, or semiconductor system (or apparatus or device). Examples of non-transitory computer-useable and computer-readable storage media include a semiconductor or solid-state memory, magnetic tape, a removable computer diskette, a random-access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Alternatively, embodiments of the invention may be implemented entirely in hardware or in an implementation containing both hardware and software elements. In embodiments which use software, the software may include but is not limited to firmware, resident software, microcode, etc.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A communications device comprising:
a controller configured to generate a protected control frame, wherein the protected control frame comprises a protected trigger frame, a protected block acknowledgement (BA) frame, or a protected block acknowledgement request (BAR) frame; and
a transceiver configured to transmit the protected control frame to a second communications device.

2. The communications device of claim 1, wherein the communications device comprises a wireless device that is compatible with an Institute of Electrical and Electronics Engineers (IEEE) 802.11 protocol.

3. The communications device of claim 1, wherein the communications device comprises a wireless multi-link device (MLD), wherein the second communications device comprises a second wireless MLD, and wherein the transceiver comprises a wireless transceiver configured to transmit the protected control frame to the second wireless MLD through a wireless link between the wireless MLD and the second wireless MLD.

4. The communications device of claim 1, wherein the protected control frame comprises the protected trigger frame, a protected compressed BAR frame, or a protected Multi-Traffic Identifier (TID) BAR frame.

5. The communications device of claim 1, wherein the protected control frame comprises a protected Multi-User Request To Send (MU-RTS) frame that is used to replace a RTS to solicit a Clear to Send (CTS) by an access point (AP) or a station (STA).

6. The communications device of claim 1, wherein the protected control frame comprises a protected multi-station (STA) BA frame.

7. The communications device of claim 6, wherein the protected multi-STA BA frame is used to replace a compressed BA frame.

8. The communications device of claim 6, wherein the protected multi-STA BA frame is used to replace a Multi-Traffic Identifier (TID) BA frame.

9. The communications device of claim 6, wherein the protected multi-STA BA frame is used to replace an acknowledgement (Ack).

10. The communications device of claim 1, wherein the controller is further configured to generate the protected control frame using a control frame peer transient key (CPTK), wherein the communications device comprises a wireless multi-link device (MLD), wherein the second communications device comprises a second wireless MLD, and wherein each wireless link between the wireless MLD and the second wireless MLD has its own packet number (PN) space.

11. The communications device of claim 1, wherein the controller is further configured to generate the protected control frame using a control frame group temporal key (CGTK), wherein the communications device comprises a wireless multi-link device (MLD), wherein the second communications device comprises a second wireless MLD, and wherein each wireless link between the wireless MLD and the second wireless MLD has its own CTGK and its own packet number (PN) space.

12. The communications device of claim 1, wherein the protected control frame comprises the protected BAR frame, and wherein key identification (ID) information and frame protection indication information are carried in a reserved subfield of a BAR control field of the protected BAR frame.

13. The communications device of claim 12, wherein packet number (PN) information and message integrity check (MIC) information are located before a frame check sequence (FCS).

14. The communications device of claim 1, wherein the protected control frame comprises the protected BA frame, and wherein key identification (ID) information and frame protection indication information are carried in a reserved subfield of a BA control field of a Media Access Control (MAC) header of the protected BA frame.

15. The communications device of claim 14, wherein packet number (PN) information and message integrity check (MIC) information are located after a last Per Association ID (AID) Traffic Identifier (TID) Info field.

16. A wireless multi-link device (MLD) comprising:
a controller configured to generate a protected control frame using a transient key or a group key, wherein the protected control frame comprises protected Trigger frame, a protected block acknowledgement (BA) frame or a protected block acknowledgement request (BAR) frame; and
a wireless transceiver configured to transmit the protected control frame to a second wireless MLD through a wireless link between the wireless MLD and the second wireless MLD.

17. The wireless MLD of claim 15, wherein the protected control frame comprises a protected compressed BAR frame or a protected Multi-Traffic Identifier (TID) BAR frame.

18. The wireless MLD of claim 15, wherein the protected control frame comprises a protected multi-station (STA) BA frame.

19. The wireless MLD of claim 15, wherein the controller is further configured to generate the protected control frame using a control frame peer transient key (CPTK), and wherein each wireless link between the wireless MLD and the second wireless MLD has its own packet number (PN) space.

20. A method for wireless communications, the method comprising:
at a first communications device, generating a protected control frame, wherein the protected control frame comprises a protected trigger frame, a protected block acknowledgement (BA) frame, or a protected block acknowledgement request (BAR) frame; and
from the first communications device, wirelessly transmitting the protected control frame to a second communications device.
